(19) United States
(12) Patent Application Publication
(10) Pub. No.: US 2010/0099071 A1
(43) Pub. Date: Apr. 22, 2010

(54) METHOD AND APPARATUS FOR AGGREGATING, ANALYZING, PRESENTING, AND MANIPULATING PROCESS DATA FOR INSTRUCTIONAL PURPOSES

(75) Inventors: Albert L. Abrahamson, Yorktown, VA (US); Corey E. Brady, Weston, FL (US); Mark D. Fry, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/603,389

(22) Filed: Oct. 21, 2009

Related U.S. Application Data
(60) Provisional application No. 61/107,198, filed on Oct. 21, 2008.

(51) Int. Cl. G09B 7/00

(52) U.S. Cl. 434/350; 434/362

(57) ABSTRACT

A method and apparatus for presenting aggregated data for instructional purposes. The method includes retrieving student responses, determining at least one bucket type and, if needed, changing the algorithmic criteria defining the at least one bucket type, aggregating the responses according to bucket type, viewing students responses in the aggregated format, wherein the responses are displayed step by step to show the process of arriving to the response, and comparing at least two students responses to each other.

### CROSS-REFERENCE TO RELATED APPLICATIONS

This application claims benefit of U.S. provisional patent application Ser. No. 61/107,198, filed Oct. 21, 2008, which is herein incorporated by reference.

### BACKGROUND OF THE INVENTION

1. Field of the Invention

Embodiments of the present invention generally relate to a method and apparatus for aggregating, analyzing, presenting, and manipulating, process data for instructional purposes.

2. Description of the Related Art

Major problems for a teacher in teaching a class of students are soliciting, observing, assimilating, and adapting to what every student thinks in a timely fashion. This is particularly true in “cumulative knowledge” subjects, such as, mathematics and science where students may have failed to fully grasp key concepts in subtle ways or may hold misconceptions that are difficult for a teacher to detect, but which can severely inhibit their learning.

For example, in the context of mathematics and science classrooms, a common activity is solving problems for which, during the solution process:
(a) there are many different ways to make errors
(b) errors in solutions reveal important misconceptions or conceptual gaps
(c) students' errors tend to cluster around a finite number of types of mistake, each of which is useful to bring to the attention of all students, to teach and reinforce correct conceptual thinking and valid strategies
(d) there may be more than one valid solution strategy.

Each of the above situations may represent a rich teaching opportunity, but in typical classrooms, it is difficult for teachers to take full advantage of this potential. The reason for this difficulty is that teachers have limited means to quickly assess how students have approached a particular problem, what errors they have made, why they have made them, how they might spring from misconceptions, or which misconceptions (or missed-conceptions) are involved.

For example, a teacher may choose to walk around the room and look at student work, or s/he may ask the class verbally soliciting individuals to describe how they solved a particular problem. However, the former option takes substantial time, and the latter gives partial information, as only a few students answer. While these are only two examples of multiple current strategies that teachers use in the situations described above, they serve well to illustrate a problem for which no good solution currently exists.

It is possible to reduce class sizes down to a few students, so the teacher can easily cover all, but this option carries large economic costs. So the teaching that follows the situations described above lacks timeliness, or is based on inaccurate information regarding student cognition.

Some technologies solve this problem by providing rapid gathering, aggregation, and display of student responses. However, these types of systems tend to focused on collecting “answers” to questions, tasks, exercises, or problems, rather than collecting the actual processes used by students in their solutions. In addition, they are limited when answers to questions are not in multiple-choice form or where the “answers” are not a defined set of choices. For example, the simpler “Clicker-type” systems only allow highly structured responses, such as, multiple choice or numeric answers to a question. More advanced systems (such as TI-Navigator 3.0), which allow for student responses with complex structures, such as, mathematical expressions or equations, are limited to provide simple text matching software tools to aggregate and display such answers from a class of students. Further, in mathematics and science, it is critical to collect data which reflect the actual processes used by students in their attempts to analyze, deconstruct, and solve problems, exercises, examples, and tasks.

Therefore, there is a need for an improved method and/or apparatus for aggregating, analyzing, presenting and manipulating data, gathered from the class, for instructional purposes. In Addition, there is a need to to aggregate, analyze, present, and manipulate process data collected from a classroom.

### SUMMARY OF THE INVENTION

Embodiments of the present invention generally relate to a method and apparatus for aggregating, analyzing, presenting, and manipulating, process data for instructional purposes. The method includes retrieving student responses, determining at least one bucket type and, if needed, changing the algorithmic criteria defining the at least one bucket type, aggregating the responses according to bucket type, viewing students responses in the aggregated format, wherein the responses are displayed step by step to show the process of arriving to the response, and comparing at least two students responses to each other.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It is also to be noted that a computer readable medium is any medium that is utilized by a computer for data storage, retrieval, deletion, archiving, execution and the like.

FIG. 1 depicts an embodiment of a flow diagram for a method for aggregating, analyzing, presenting, and manipulating, process data for instructional purposes;

FIG. 2 depicts another embodiment of a flow diagram for a method for aggregating, analyzing, presenting, and manipulating, process data for instructional purposes;

FIG. 3 depicts yet another different embodiment of a flow diagram of a method for aggregating, analyzing, presenting, and manipulating, process data for instructional purposes;

FIG. 4 depicts an embodiment of a system for acquiring data for instructional purposes; and

FIG. 5 depicts and embodiment of an apparatus for aggregating analyzing, presenting, and manipulating, process data for instructional purposes.

### DETAILED DESCRIPTION

The method and apparatus for aggregating, analyzing, presenting, and manipulating, process data, for instructional purposes, described herein is intended for mathematical data, science data, and the like. Specifically, where such data represent student processes aimed at analyzing, deconstructing, and solving problems, exercises, examples, and tasks.

In one embodiment, the method first aggregates the data, where such aggregation is defined by some instructional criteria related a problem, exercise, example, or task “type”, and employs student answers using a math engine, such as, CAS, with a parsing algorithm, to categorize such data according to the said criteria. Thus, the method and apparatus for presenting aggregated data for instructional purposes may produce various forms of mathematical presentation derived through the process of pedagogically meaningful intelligent data aggregation. For example, all the students who obtained the correct answer may be in a single bin or bucket, whereas other students who made the same mistake might all be in grouped in a second bucket, and students with another error in a third bucket. Typically, in this situation, the teacher would know how many students how many students had got the correct answer an how many had got it wrong, but would not know how different students had obtained their answers. This embodiment solves the problem by providing the teacher with the steps, which each student took to solve the problem. Thus, the teacher could look at the process steps of all the students in the second bucket as two processes set side-by-side, or with all processes tiled on a screen, or could flip through them one-by-one, etc., and could quickly see what mistake the students in this bucket have in common. To assist the teacher further, this embodiment also permits the teacher to a math engine such as CAS with an intelligent parsing algorithm, to scan student process steps and automatically flag the step where each student made a mistake.

In one embodiment, through the technology of a response system or classroom network supporting open-ended text generation, it is possible to create the facility for students to enter their work electronically and submit it to the teacher's computer. The system structure and/or hardware components, within which a teacher receives the data for instructional purposes across a large number of physical, electronic, and communications configurations. For example, a teacher may receive data from a classroom network of calculators, handheld computers, laptops, notebooks, desktops, or the like. In one embodiment, the data may be transmitted over a dedicated wired or wireless classroom network, over the internet from a “virtual” classroom, via a “homework” system, asynchronously in a distance learning context, and the like. The data may relate to a question asked, tasks or activities assigned to students, and the like. The aggregation method and/or apparatus analyze the data for patterns, performs aggregation, allows presentation, and/or enables manipulation in similar ways. For example, utilizing the technology of a math engine, such as, computer algebra system (CAS), and intelligent parsing algorithm, it is possible to compare the various components (steps) of data, such as, students' submissions, both with the steps of other students and with the other steps of the same student's submission.

In one embodiment, the comparison of final-steps (solutions) is done across students, categorizing student work according to the end result of the problem-solving process. Within the aggregating or sub-aggregation that results, students may or may not have followed the same pathway to the answer. Thus, we allow flexible side-by-side comparison of these students' set of steps or solutions.

In addition, utilizing a math engine, such as, CAS tools, the steps within a student's solution may be compared and analyzed. As such, comparing successive steps for validity or errors may be analyzed. This comparison serves to identify steps in the sequence in which the student has produced a step which is NOT equivalent or logically deducible from the prior step, hence, indicating a mathematical error. In one embodiment, the steps with mathematical error may be highlighted, which allows the classroom to discuss, focus on the sources of error and/or identify common sources of errors across multiple students' work.

By way of example, we give four examples from Algebra I courses. However, this innovation is not limited to the subject matter of these examples.

### EXAMPLE 1

This includes classes of problems that, in typical language, ask students to; (a) Simplify an expression, (b) Combine like terms, (c) Compute the product, (d) Factor the expression. In this example, for each of these problems, the answer is an algebraic expression that, in mathematical terms, is equivalent to the original expression given in the problem. Also, each step of the solution process should be an expression that is similarly equivalent to the one before it, and to the original expression itself.

Therefore, if one wishes to determine where a student has made a mistake, it is possible to scan down each successive line of the student's solution, to find whether mathematical equivalence with the preceding line is preserved. If equivalence is preserved, then no error has yet been made. If equivalence is not present, then the student has made an error. Thus, it is possible to mark for a teacher, the exact line on which the student has made an error.

This may be done using a math engine, such as, a CAS, and an intelligent parsing. In such an example, the method and/or apparatus may be capable of scanning student solutions for problems and of searching for the solution step at which mathematical equivalence with the problem statement or previous solution step is no longer preserved.

### EXAMPLE 2

In one embodiment, the problems may involve linear equations in one or two variables. Typically these begin with the words: (a) Solve the equation, (b) Solve the equation for X, (c) Solve the equation for Y, (d) Put in slope-intercept form, (e) Simplify the equation. For each of these problems, the answer is an equation with a solution that is equivalent, in mathematical terms, to the solution of the original equation given in the problem. Also, each step of the solution process is an equation with a solution that is similarly equivalent to the solution of the step before it and to the original equation itself.

Therefore, to determine where a student has made a mistake, it is possible to scan down each successive line of the student's solution, to find whether the solution is mathematically equivalent with the solution of the equation on the preceding line. If equivalence is preserved, then no error has yet been made. If equivalence is not present, then the student has made an error. Thus, it is possible to mark for a teacher, the exact line on which the student has made an error.

This may be done using a math engine, such as, a CAS, and an intelligent parsing. In such an example, the method and/or apparatus may be capable of scanning student solutions for problems and of searching for the solution step at which mathematical equivalence with the problem statement or previous solution step is no longer preserved.

### EXAMPLE 3

In one embodiment, the problem may involve quadratic equations. Typically these begin with the words: (a) Solve the equation, (b) Find the roots of the equation, (c) Solve the equation by factoring, (d) Simplify the equation by completing the square, (e) Solve the equation using the quadratic formula. This may be similar to example 2 above except that there are two answers instead of one, which have to be compared for mathematical equivalency at each step.

### EXAMPLE 4

This includes classes of problems consisting of two linear equations in the same two variables that typically begin with the words: (a) Solve the system of equations, (b) Solve the simultaneous equations, (c) Solve the system using substitution, (d) Solve the system by elimination. For each of these problems, the answer may consist of two equations or more, with each equation expressing a solution for one variable. This solution is either a numerical value or an expression, which is independent of the other variable.

The solution to the original equations given in the problem is also the solution to selected pairs of equations, which the student develops as steps in solving the problem. The difficulty in automated analysis lies in deciding which pair of equations comprise the new system and is appropriate to feed into the math engine at each step to evaluate whether the student has made an error.

One of the pair is the equation given at the step under consideration. Usually, one needs to know the operation the student intends to carry out at the present step. One possibility is to assign numbers to each equation/line of the solution and require the student to specify what operation s/he was intending to perform on which equation, to yield the new equation at the current step. With this information, it is possible to determine a prior independent equation and use it to determine the correctness of the current step.

Another option is simply to start with the first equation at the beginning of the solution and if this equation is not independent of the one at the current step, cycle through successive steps until an independent one is found, which can then be used to confirm whether the resulting solution is mathematically equivalent to the solution for the original problem.

An application of these concepts and principles to areas of mathematics beyond Algebra I is also contemplated as being within the scope of the current invention. Such application will be within the capability of practitioners skilled in the state of the art.

The use of a math engine and an intelligent parsing algorithm provide real-time analysis of students' solutions processes. To this date, student response systems have only made analyses of students' final answers. Even at that level, student response systems have not tended to do subject-matter-specific analysis (for example, treating the response as a mathematical object, such as an expression or equation). Still less have response systems made any attempt to do analysis and display of student thinking processes behind their answers.

The alternative approach is a labor-intensive, non-real-time analysis of student papers by the teacher. Real-time analysis opens up the potential for energetic discussion of student work during class and when the solutions and errors are still fresh in the students' minds. This has a positive effect on learning, as the students get immediate feedback about their strengths and weaknesses. Because the work can be anonymous, the classroom discussion can proceed without embarrassing the individual students whose work is being discussed.

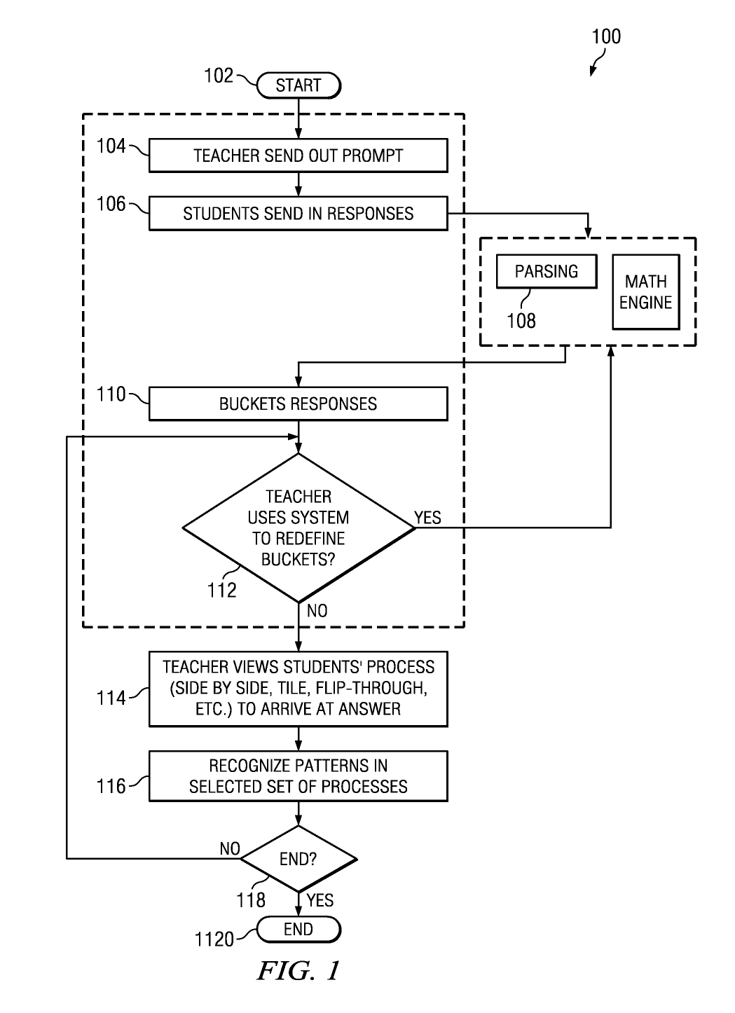

FIG. 1 depicts an embodiment of a flow diagram for a method 100 for aggregating, analyzing, presenting, and manipulating, process data for instructional purposes. The method 100 starts at step 102 and proceeds to step 104. At step 104, the teacher sends out a prompt requesting the students' responses or presenting a problem. At step 106, the teacher receives the students' response to the prompt. At step 108, the teacher parses the response and utilizes a math engine to bucket the responses. At step 110, the responses are bucketed. At step 112, the teacher may choose to refine the buckets. If the teacher opts to refine the buckets, the method 100 proceeds to step 108 to parse the response and to utilize the math engine for refining the buckets. Otherwise, the method 100 proceeds to step 114. At step 114, the teacher views students' process, i.e. side by side, tile, flip-through, etc., to arrive at the answer for one bucket or more; such process may relate to an algebraic solution, graph, drafting a figure and the like. At step 116, the method 100 recognizes patterns in selected set of processes, in which the method 100 may parse the information and utilize a math engine. The method 100 proceeds to step 118. At step 118, the method 100 determines if there is more data to process. If there is more data, the method 100 proceeds to step 112; otherwise, the method 100 proceeds to step 120. The method 100 ends at step 120.

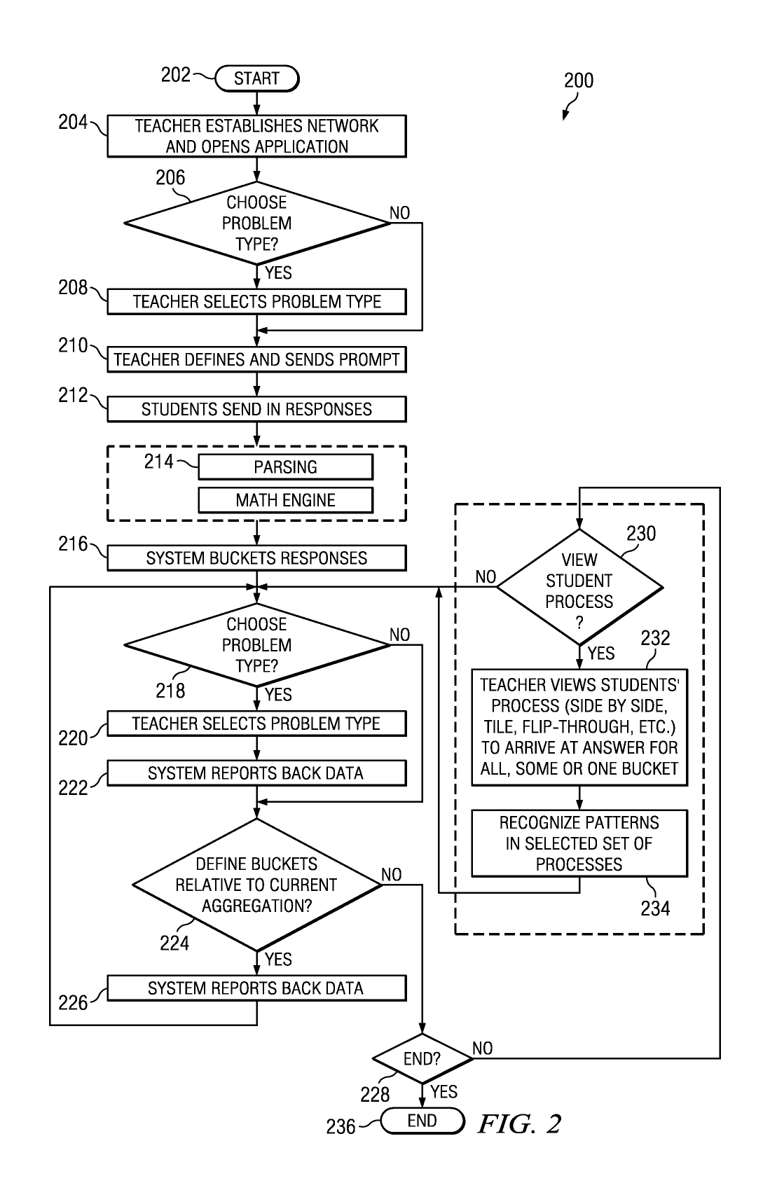

FIG. 2 depicts another embodiment of a flow diagram for a method 200 for aggregating, analyzing, presenting, and manipulating, process data for instructional purposes. The method 200 starts at step 202 and proceeds to step 204. At step 204, the teacher may establish a network and opens an application to allow for classroom data exchange. At step 206, the method 200 determines if the teacher chooses a problem type; examples of problem types are defined above. If the teacher chooses the problem type, the method 200 proceeds to step 208, wherein the teacher's problem type is selected; otherwise, the method 200 proceeds to step 210. At step 210, the teacher defines and sends prompt. At step 212, the students send in responses. At step 214, the method 200 parses and utilizes a math engine to prepare for response bucketing. At step 216, the method 200 buckets the responses. At step 218, the method 200 determines if the problem type is to be selected. If the problem type is to be chosen, the method 200 proceeds to step 220, wherein the teacher selects the problem type. The method 200 may parse and utilize a math engine to switch to the new problem type. From step 220, the method proceeds to step 222, wherein the method 200 reports the new problem type and then proceeds to step 224. If the problem type is not to be selected, the method 200 proceeds to step 224. At step 224, the method 200 determines if buckets are needed relative to the current aggregation. If buckets are needed, the method 200 proceeds to step 226, wherein the method 200 reports the data; otherwise, the method 200 proceeds to step 228. If buckets are needed, the method 200 may parse that data and utilize a math engine for determining the buckets. From step 226, the method 200 proceeds to step 218.

At step 228, the method 200 determines if the aggregation is ended. If it is not ended, the method 200 proceeds to step 230; otherwise, the method 200, proceeds to step 232. At step 232, the teacher views the students' (i.e. side by side, tile, flip-through, etc.), to arrive at the answer for one bucket or more; such process may relate to an algebraic solution, graph, drafting a figure and the like. At step 234, the method 200 recognizes patterns in selected set of processes for comparing at least two students answers to each other, in which the method 200 may parse the information and utilize a math engine. From step 234, the method 200 proceeds to step 218. The method 200 ends at step 240.

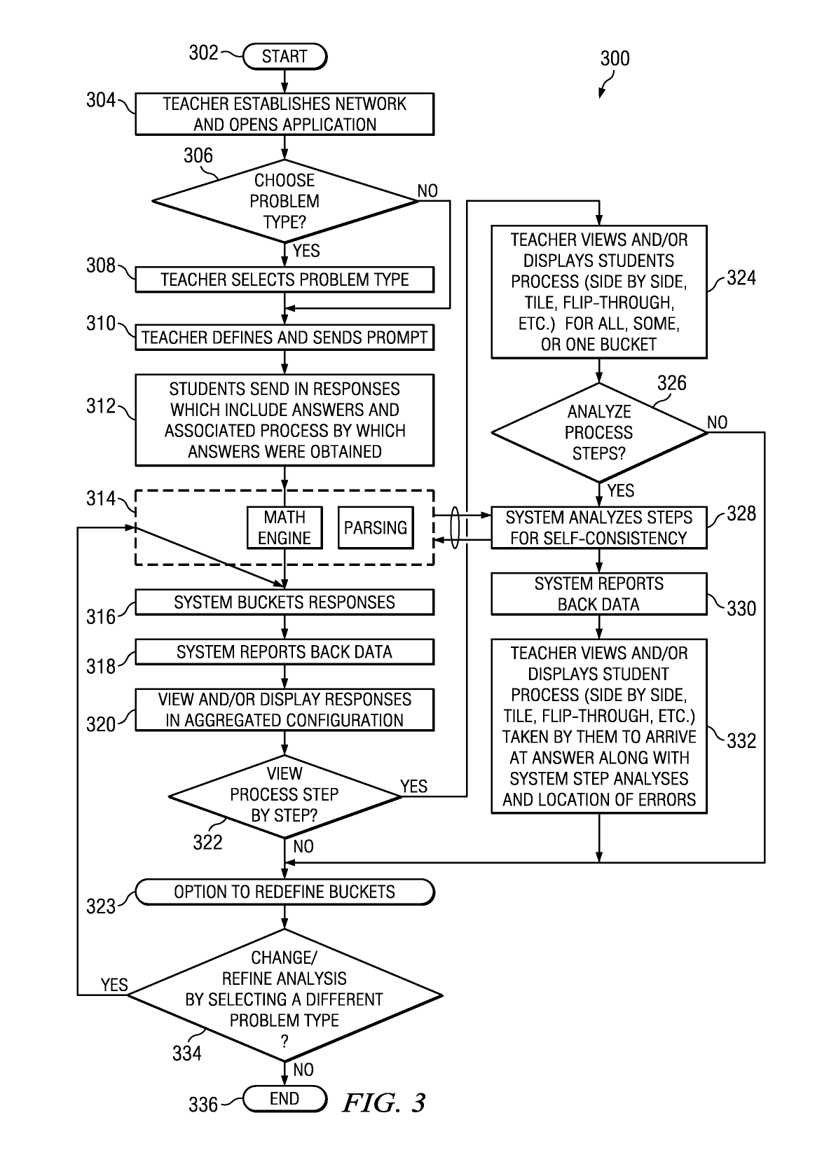

FIG. 3 depicts yet another embodiment of a method 300 for aggregating, analyzing, presenting, and manipulating, process data for instructional purposes. The method 300 starts at step 302 and proceeds to step 304. At step 304, the teacher may establish a network and opens an application to allow for classroom data exchange. At step 306, the method 300 determines if the teacher chooses a problem type; examples of problem types are defined above. If the teacher chooses the problem type, the method 300 proceeds to step 308, wherein the teacher's problem type is selected; otherwise, the method 300 proceeds to step 310.

At step 310, the teacher may define and send prompt. At step 312, the students send in responses. At step 314, the method 300 parses and utilizes a math engine to prepare for response bucketing. At step 316, the method 300 buckets the responses. At step 318, the method 300 reports back data. At step 320 the teacher may view and/or display responses in aggregated configuration. At step 322, the teacher may select to view student process steps. At 324, the teacher may view and/or display student process in a variety of alternate configurations for all, some, or one bucket. At step 326 the method 300 determines if the teacher elects to perform automatic analysis of process steps. If this option is selected the method 300 proceeds to step 328, where the method 300 analyzes steps within each of the selected students' processes for self-consistency, and locates errors. At step 320 the system reports back data. At step 322, the teacher views &/or displays student processes taken by them to arrive at their answers along with system step analyses indicating the location of errors in student processes. At steps 323 and 334 the method 300 permits changes or refinement to the algorithmic criteria defining the bucketing process which includes the possibility of selecting a different problem type. If no changes are destre the method 300 ends at step 336.

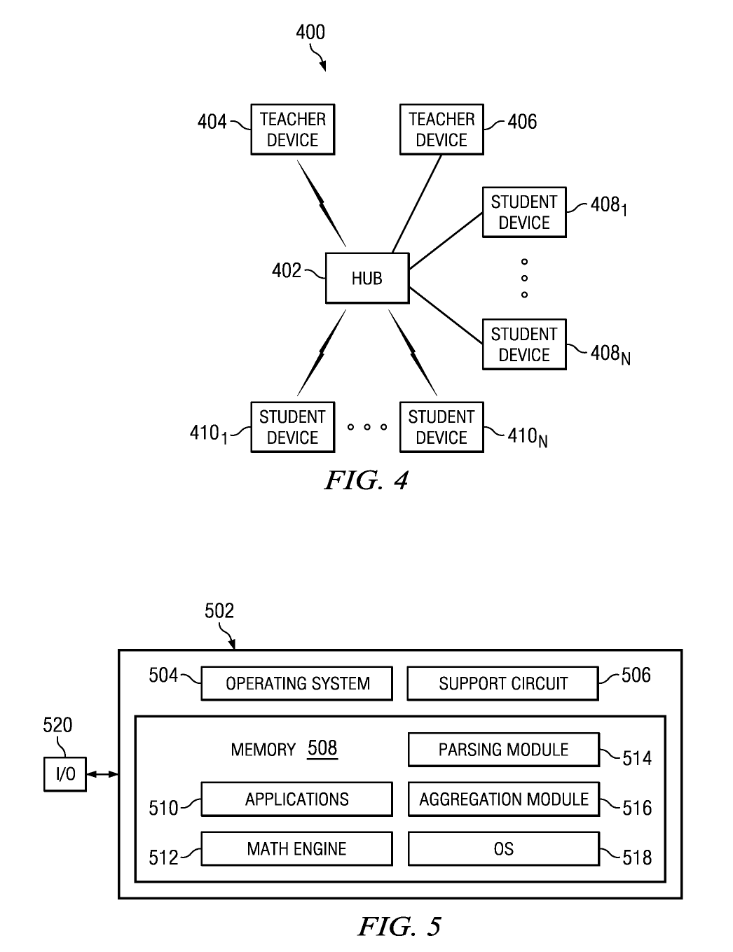

FIG. 4 depicts an embodiment of a system 400 for aggregating data for instructional purposes. The system 400 includes a hub 402, wireless teacher device 404, teacher device 406, student device 408 (408₁-408_{N}) and wireless student device 410 (410₁-410_{N}). The hub 402 facilitates communication between the student devices 408, 410 and the teacher devices 404, 406. The hub 402 may be a personal computer, a laptop, a handheld device or the like. The hub 402 may be utilized as a teacher device or a student device or maybe a dedicated hub for creating a network or facilitating communication. The student devices 408, 410 and the teacher devices 404, 406 may be a personal computer, a laptop, a handheld device or the like.

The wireless teacher device 404 is capable of communicating wirelessly with the hub 402 and the teacher device 408. The teacher device 404, 406 is capable of communicating with the hub 302 and the teacher device 408. If should be noted that the system 400 may include one of a wireless teacher device 404 or a teacher device 403; furthermore, the wireless teacher device 404 and a teacher device 403 maybe combined into the same device that may be utilized wirelessly or directly coupled to the hub 402. The system 400 may include any number of wireless teacher device 404 or the teacher device 406. The teacher utilizes the teacher device 404, 406 to prompt the students and to receive students' responses. The hub 402 and/or the teacher device 404, 406.

The wireless student device 410 is capable of communicating wirelessly with the hub 402 and the teacher device 404, 406. The student device 408, 410 is capable of communicating with the hub 402 and the student device 408. It should be noted that the system 400 may include one of a wireless student device 410 or a student device 408; furthermore, the wireless student device 410 and a student device 408 maybe combined into the same device that may be utilized wireless or directly coupled to the hub 402. The system 400 may include any number of wireless student devices 410 or the student device 408. The student utilizes the student device 408, 410 to respond and to communicate with the teacher, to receive teachers' prompt.

FIG. 5 depicts and embodiment of an apparatus 502 for aggregating data for instructional purposes. The apparatus 502 includes a central processing unit (CPU) 504, support circuit 506 and memory 508. The CPU 502 may comprise one or more conventionally available microprocessors. The microprocessor may be an application specific integrated circuit (ASIC). The support circuits 506 are well known circuits used to promote functionality of the CPU 504. Such circuits include, but are not limited to, a cache, power supplies, clock circuits, input/output (I/O) devices 520 and the like.

The memory 508 may comprise random access memory, read only memory, removable disk memory, flash memory, and various combinations of these types of memory. The memory 508 is sometimes referred to main memory and may, in part, be used as cache memory or buffer memory. The memory 508 may store an operating system (OS) 518, various forms of application 510, a math engine 512, a parsing module 514 and an aggregation module 516. The aggregation module 516 performs any of the methods described in FIGS. 1, 2 and/or 3.

While the foregoing is directed to embodiments of the present invention, other and further embodiments of the invention may be devised without departing from the basic scope thereof, and the scope thereof is determined by the claims that follow.

What is claimed is:

1. A method for presenting aggregated data for instructional purposes, the method comprising:
retrieving student responses;
determining at least one bucket type and, if needed, changing the algorithmic criteria defining the at least one bucket type;
aggregating the responses according to bucket type;
viewing students responses in the aggregated format, wherein the responses are displayed step by step to show the process of arriving to the response; and
comparing at least two students responses to each other.

2. The method of claim 1, wherein the step of changing the algorithmic criteria comprises at least one act of parsing the response or utilizing a math engine.

3. The method of claim 2, wherein the math engine is a CAS engine.

4. The method of claim 1, wherein the method if performed in real-time as a student's response is being retrieved.

5. The method of claim 1, wherein the responses are being retrieved from a student's calculator.

6. The method of claim 1, wherein the bucket type relates to an environment.

7. The method of claim 6, wherein the environment is at least one of symbolic, graphical, geometric, coordinate grid, model, or algebra tiles.

8. The method of claim 1, wherein the responses are in at least one of symbolic form, algebraic steps, algebraic expression, equation, graphic form, graphic construction, or model form.

9. The method of claim 1, wherein the responses are triggered by a teacher's prompt.

10. The method of claim 1 further comprising repeating the steps to view the aggregation different environments.

11. The method of claim 1, wherein the process of viewing student responses comprises automated identification of errors in the student processes.

12. The method of claim 1, wherein the process of viewing student responses comprises pattern searching for errors in student processes.

13. An apparatus for presenting aggregated data for instructional purposes, the comprising:
means for retrieving student responses;
means for determining at least one bucket type and, if needed, changing the algorithmic criteria defining the at least one bucket type;
means for aggregating the responses according to bucket type;
means for viewing students responses in the aggregated format, wherein the responses are displayed step by step to show the process of arriving to the response; and
means for comparing at least two students responses to each other.

14. The method of claim 13, wherein the student responses are retrieved via at least one of a wired network, a wireless network, a “virtual” classroom network, a “homework” system, or an internet asynchronously in a distance learning context.

15. The apparatus of claim 13, wherein the means for changing algorithmic criteria comprises at least one of means for parsing the response or means for utilizing a math engine.

16. The apparatus of claim 15, wherein the math engine is a CAS engine.

17. The apparatus of claim 13, wherein the apparatus is utilized in real-time as the students' responses are being retrieved.

18. The apparatus of claim 13, wherein the responses are being retrieved from at least one of a calculator, a handheld computer, a laptop computer, a notebook computer, a desktop computer, a tablet computer, a cellphone, or a media player.

19. The apparatus of claim 13, wherein the bucket type relates to an environment.

20. The apparatus of claim 19, wherein the environment is at least one of symbolic, graphical, geometric, coordinate grid, model, or algebra tiles.

21. The apparatus of claim 13, wherein the responses are in at least one of symbolic form, algebraic steps, algebraic expression, equation, graphic form, graphic construction, or model form.

22. The apparatus of claim 13, wherein the responses are triggered by a teacher's prompt.

23. The apparatus of claim 13 further comprising repeating the steps to view the aggregation different environments.

24. A computer readable medium, comprising executable instructions, when executed, perform a method for presenting aggregated data for instructional purposes, the method comprising:
retrieving student responses;
determining at least one bucket type and, if needed, changing the responses according to the at least one bucket type;
aggregating the responses according to bucket type;
viewing students responses in the aggregated format, wherein the responses are displayed step by step to show the process of arriving to the response; and
comparing at least two students answers to each other.

25. The computer readable medium of claim 24, wherein the step of changing the responses comprises at least one of parsing the response or utilizing a math engine.

26. The computer readable medium of claim 25, wherein the math engine is a CAS engine.

27. The computer readable medium of claim 24, wherein the method if performed in real-time as a student response is being retrieved.

28. The computer readable medium of claim 24, wherein the responses are being retrieved from a student's calculator.

29. The computer readable medium of claim 24, wherein the bucket type relates to an environment.

30. The computer readable medium of claim 29, wherein the environment is at least one of symbolic, graphical, geometric, coordinate grid, model, or algebra tiles.

31. The computer readable medium of claim 214 wherein the responses are in at least one of symbolic form, algebraic steps, algebraic expression, equation, graphic form, graphic construction, or model form.

32. The computer readable medium of claim 24, wherein the responses are triggered by a teacher's prompt.

33. The computer readable medium of claim 24 further comprising repeating the steps to view the aggregation different environments.

34. The computer readable medium of claim 24, wherein the process of viewing student responses comprises automated identification of errors in the student processes.

35. The computer readable medium of claim 24, wherein the process of viewing student responses comprises pattern searching for errors in student processes.
